(19) United States
(12) Patent Application Publication
(10) Pub. No.: US 2019/0302375 A1
(43) Pub. Date: Oct. 3, 2019

(54) OPTICAL WAVEGUIDE AND OPTICAL CONNECTOR

(71) Applicant: FUJITSU COMPONENT LIMITED, Tokyo (JP)

(72) Inventors: Kazuhiro Yoshida, Tokyo (JP); Takeshi Okuyama, Tokyo (JP); Takatoshi Yagisawa, Tokyo (JP)

(21) Appl. No.: 16/357,743

(22) Filed: Mar. 19, 2019

(30) Foreign Application Priority Data
Mar. 28, 2018 (JP) 2018-061590

(51) Int. Cl. G02B 6/38

(52) U.S. Cl. CPC G02B 6/3861; G02B 6/3853

(57) ABSTRACT

An optical waveguide for connection to a ferrule includes a plurality of cores and a cladding covering the cores, wherein the cladding has recesses at an end face of the optical waveguide.

### BACKGROUND OF THE INVENTION

### 1. Field of the Invention

The disclosures herein relate to an optical waveguide and an optical connector.

### 2. Description of the Related Art

Due to demands for increases in the speed and density of interconnections within information processing apparatuses to achieve higher performance, there are optical interconnection technologies that utilize high-speed optical transmission for the transmission of signals inside apparatuses. An optical connector made by combining an optical waveguide with a ferrule is used for connecting an optical waveguide with another optical device for use in optical interconnection technologies.

Reduction in the transmission efficiency of optical signals is recognized as one of the problems with respect to an optical connector. For example, a penetrating hole communicating with the outside of a ferrule may be provided in the container section of the ferrule for accommodating a tip of an optical waveguide (see Patent Document 1).

When the tip of an optical waveguide is inserted into and bonded to the container section that is filled with an adhesive, bubbles created in the optical path between the cores of the optical waveguide and the container section are ejected to the outside of the ferrule through the penetrating hole. With this arrangement, reduction in optical transmission efficiency which would be caused by the optical loss resulting from bubbles, i.e., Fresnel reflection loss, is prevented by removing the bubbles in the optical path.

In the above-noted configuration, however, bubbles may fail to be ejected to the outside through the penetrating hole, thereby remaining in the optical path between the cores of an optical waveguide and the end of the container section.

Accordingly, there may be a need for an optical waveguide and an optical connector which prevent bubbles from remaining in the optical path upon bonding the optical waveguide to a ferrule.

### RELATED-ART DOCUMENTS

### Patent Document

[Patent Document 1] Japanese Patent Application Publication No. 2015-22130

### SUMMARY OF THE INVENTION

It is a general object of the present invention to provide an optical waveguide that substantially obviates one or more problems caused by the limitations and disadvantages of the related art.

According to an embodiment, an optical waveguide for connection to a ferrule includes a plurality of cores and a cladding covering the cores, wherein the cladding has recesses at an end face of the optical waveguide.

According to at least one embodiment, an optical waveguide is provided that prevents bubbles from remaining in the optical path upon bonding the optical waveguide to a ferrule.

### BRIEF DESCRIPTION OF THE DRAWINGS

Other objects and further features of the present invention will be apparent from the following detailed description when read in conjunction with the accompanying drawings, in which:

FIGS. 1A through 1D are drawings illustrating an example of an optical waveguide;

FIG. 2 is a drawing illustrating the arrangement of components before the optical waveguide is pressed against a contact face;

FIGS. 3A through 3C are drawings illustrating the arrangement of components when the optical waveguide is pressed against a contact face;

FIGS. 4A through 4D are drawings illustrating an optical waveguide according to an embodiment;

FIGS. 5A through 5C are drawings illustrating a ferrule according to the embodiment;

FIGS. 6A through 6C are drawings illustrating an optical connector according to the embodiment;

FIG. 7 is a drawing illustrating the arrangement of components when an end face of the optical waveguide is pressed against the contact face of a slit;

FIGS. 8A and 8B are drawings illustrating a process of making holes through the optical waveguide according to the embodiment;

FIGS. 9A and 9B are drawings illustrating a process of cutting the optical waveguide according to the embodiment;

FIGS. 10A through 10D are drawings illustrating a process of bonding the optical waveguide to the ferrule; and

FIG. 11 is a flowchart illustrating a method of making the optical connector according to the embodiment.

### DESCRIPTION OF THE EMBODIMENTS

In the following, embodiments will be described with reference to the accompanying drawings. In these drawings, the same elements are referred to by the same references, and a description thereof may be omitted. In the drawings, an arrow designated by “X” indicates the width direction of an optical waveguide, and an arrow designated by “Y” indicates the direction of optical transmission along the optical waveguide, with an arrow designated by “Z” indicating the thickness direction of the optical waveguide.

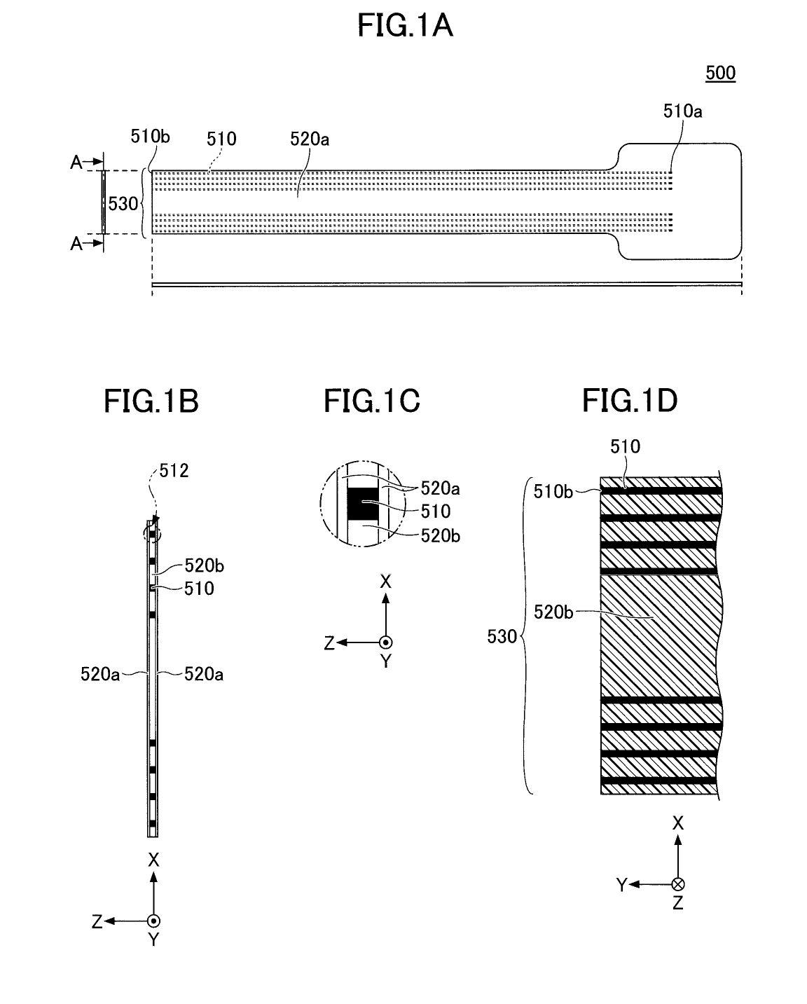

The configuration of an optical waveguide and the state of bubbles remaining inside an optical connector provided with the optical waveguide will be described with reference to FIGS. 1A through 1D, FIG. 2, and FIGS. 3A through 3C.

FIGS. 1A through 1D are drawings illustrating an optical waveguide 500. FIG. 1A illustrates three views of the optical waveguide 500. FIG. 1B is an enlarged view of an end face 530 of the optical waveguide 500. FIG. 1C is an enlarged view of an area 512 indicated by a two-dot and dash line in FIG. 1B. FIG. 1D is a cross-sectional view taken along the line indicated by arrows A in FIG. 1A.

The optical waveguide 500 includes cores 510, claddings 520a, and claddings 520b. As illustrated in FIGS. 1B and 1C, the cores 510 and the claddings 520b are sandwiched between the claddings 520a. Further, each of the cores 510 is coated with the claddings 520a and the claddings 520b.

The cores 510, the claddings 520a, and the claddings 520b are made of resin. The cores 510 have a higher refractive index than the claddings 520a and the claddings 520b.

In FIG. 1A, light entering an end 510a of the cores 510 exits from the other end 510b. Further, light entering the end 510b of the cores 510 exits from the end 510a.

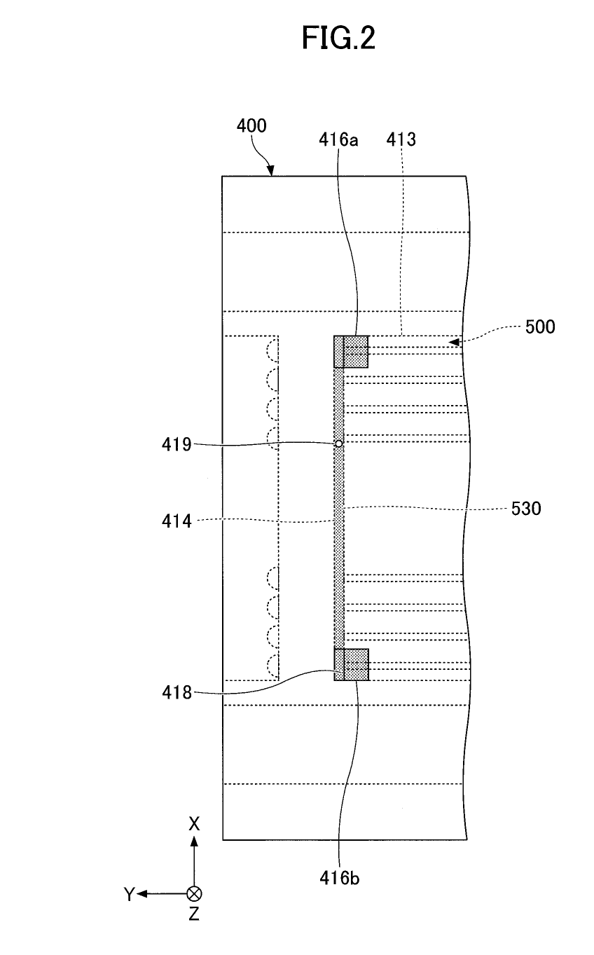

The optical waveguide 500 is connected to a ferrule to constitute an optical connector. FIG. 2 is a drawing illustrating the point at which the optical waveguide 500 and a ferrule 400 are connected to each other.

In FIG. 2, a slit 413 which is a rectangular recess for accommodating the tip of the optical waveguide 500 is formed inside the ferrule 400. The end of the slit 413 has a contact face 414 to which the end face 530 is bonded.

Penetrating holes 416a and 416b penetrating through the ferrule 400 in the Z direction are formed at the side edges of the slit 413 to make the inside of the slit 413 communicate with the outside of the ferrule 400.

The optical waveguide 500 is inserted into the slit 413 filled with an adhesive, with the end face 530 pressed against the contact face 414. The adhesive is cured in this state, so that the optical waveguide 500 is bonded to the ferrule 400.

FIG. 2 illustrates the state immediately before the end face 530 is pressed against the contact face 414. In FIG. 2, a portion 418 shown in gray indicates an adhesive present between the end face 530 and the contact face 414. A bubble 419 is depicted in the adhesive 418.

Micro-lenses are formed at the end of the ferrule 400. The centers of the cores need to be aligned with the centers of the micro-lenses so as to align the optical axes. The position of the optical waveguide 500 is controlled by the slit 413 upon being inserted thereinto, so that the insertion of the optical waveguide 500 into the slit 413 serves to align the optical axes. To this end, the thickness and width of the slit 413 are substantially identical to the thickness and the width of the tip of the optical waveguide 500, respectively, with little gaps between the optical waveguide 500 and the slit 413. With such an arrangement, a bubble trapped in the adhesive upon bonding the optical waveguide 500 to the ferrule 400 has very limited space to escape. The bubble may sometimes remain trapped between the end face 530 and the contact face 414.

The presence of a bubble in the optical path of a core causes light to reflect upon the interface between the bubble and the adhesive, thereby creating Fresnel reflection loss. Fresnel reflection loss refers to the optical loss that is caused by the reflection of incident light on a surface between mediums having different refractive indexes. Fresnel reflection loss reduces the optical transmission efficiency of an optical waveguide.

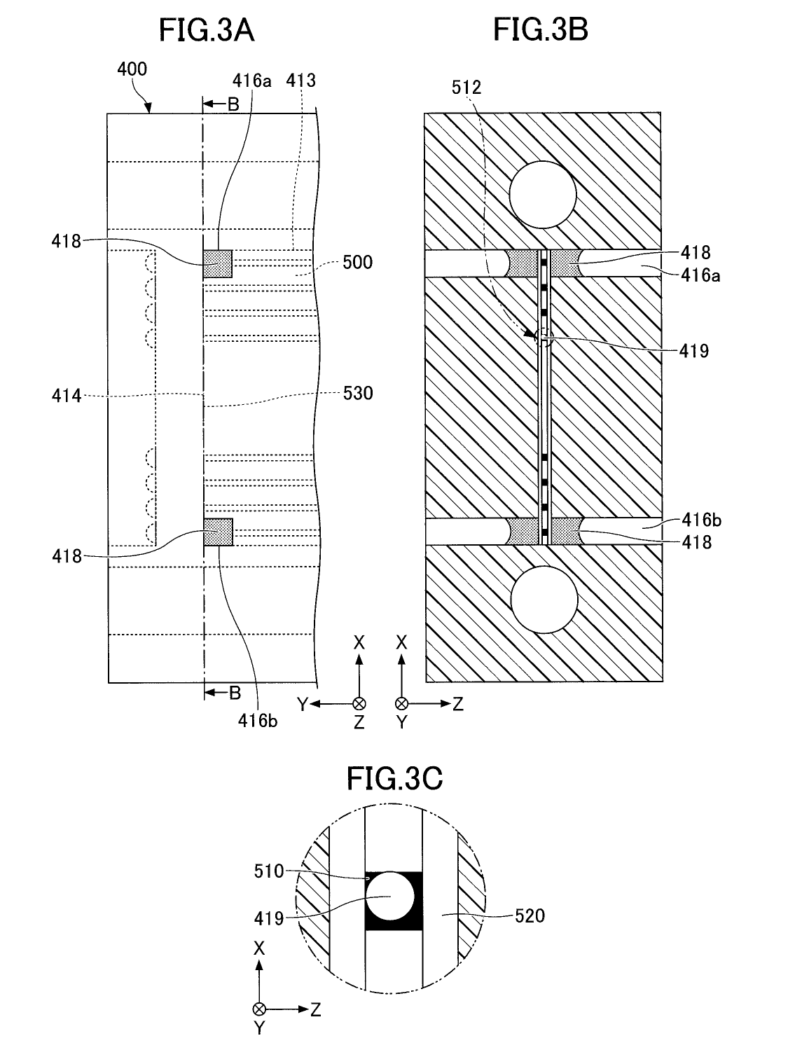

FIGS. 3A through 3C are drawings illustrating the end face 530 pressed against the contact face 414, and depict how a bubble ends up getting trapped. FIGS. 3A through 3C illustrate the state observed when the optical waveguide 500 is inserted further into the slit 413 from the state illustrated in FIG. 2.

FIG. 3A is a top view of the connection point between the optical waveguide 500 and the ferrule 400. FIG. 3B is a cross-sectional view taken along the line specified by arrows B in FIG. 3A. FIG. 3C is an enlarged view of the area 512 in FIG. 3B. In FIG. 3A, the adhesive 418 intervenes between the end face 530 and the contact face 414.

Bubbles trapped in a liquid generally adhere to an interface such as a surface of a solid object. Bubbles trapped in the adhesive adhere to the end face 530 or the contact face 414 inside the slit 413. However, bubbles having relatively large diameters, which tend to receive a relatively great force from the flow of the adhesive, are likely detached from the end face 530 or the contact face 414 to move along the flow of the adhesive. These bubbles move to the side edges of the slit 413 when the end face 530 is brought closer to the contact face 414 for bonding the optical waveguide 500 to the ferrule 400. The bubbles then pass through the penetrating hole 416a or 416b to exit to the outside of the ferrule, so that no bubbles remain between the end face 530 and the contact face 414.

In contrast, bubbles with relatively small diameters and thus relatively small volumes, which do not readily receive the force of adhesive flow, are not likely to move along the flow of the adhesive. As a result, these bubbles are not discharged to the outside of the ferrule through the penetrating holes when the end face 530 is brought closer to the contact face 414. As illustrated in FIG. 3B, some of the bubbles remain in the adhesive between the end face 530 and the contact face 414. Illustration of bubbles is omitted in FIG. 3A.

The presence of the bubble 419 in the optical path as illustrated in FIG. 3C causes Fresnel reflection loss as was previously described.

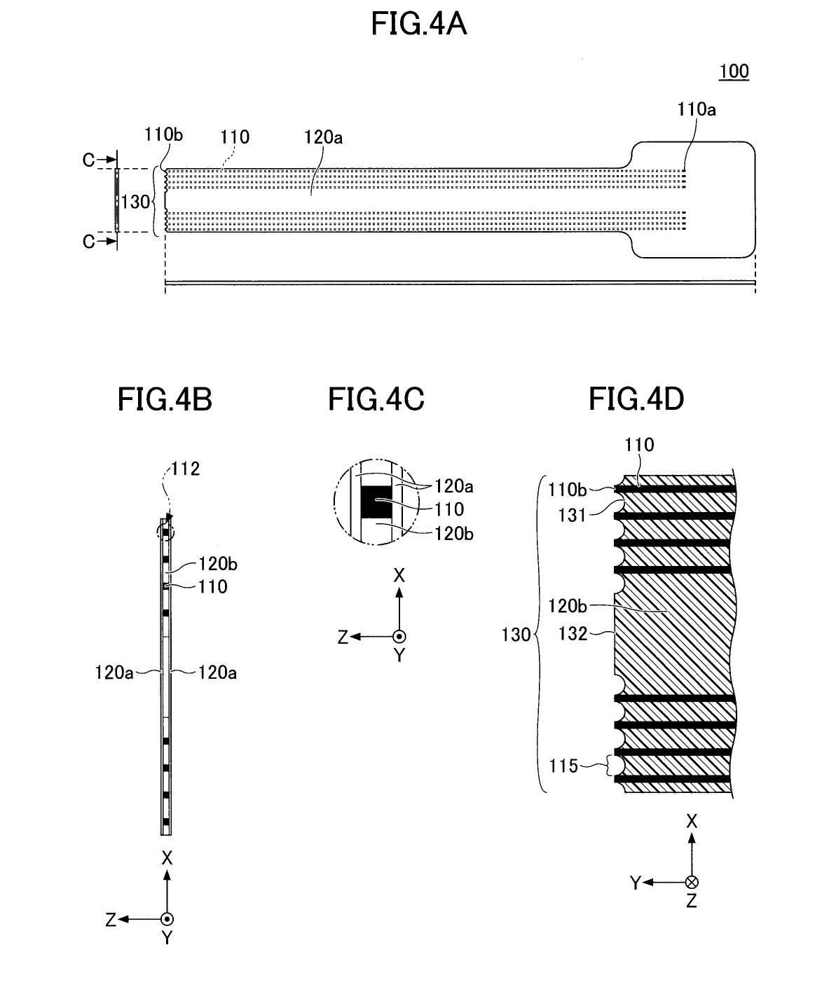

An optical waveguide, a ferrule, and an optical connector according to the present embodiment will be described with reference to FIGS. 4A to 4D through FIG. 7.

FIGS. 4A through 4D are drawings illustrating an optical waveguide according to the present embodiment. FIG. 4A illustrates three views of an optical waveguide 100. FIG. 4B is an enlarged view of an end face 130 of the optical waveguide 100. FIG. 4C is an enlarged view of an area 112 in FIG. 4B. FIG. 4D is a cross-sectional view taken along the line indicated by arrows C in FIG. 4A.

The optical waveguide 100, which has a three-layer film structure, includes a plurality of cores 110, claddings 120a, and claddings 120b. As illustrated in FIGS. 4B and 4C, a layer containing the cores 110 and the claddings 120b is sandwiched between the two claddings 120a.

The cores 110, which extend in the Y direction, have rectangular cross-sections as illustrated in FIG. 4C. The cores 110 are coated and covered with the claddings 120a and the claddings 120b. As illustrated in FIG. 4B, the cores 110 are arranged side by side at equal intervals in the X direction. The optical waveguide 100 have four cores on each side, with an empty center area provided between the two sides.

The cores 110, the claddings 120a, and the claddings 120b are made of resin, for example. The cores 110 have a higher refractive index than the claddings 120a and the claddings 120b.

The end face 130 of the optical waveguide 100 is a plane intersecting the cores 110. The end face 130 includes an end 110b of each core and a cladding covering the end.

The cladding on either side of each core at the end face 130 has a recess 131 as illustrated in FIG. 4D. The recess 131 is a cylindrical concave surface recessed from the end face 130. The cylindrical shape refers to a shape made by cutting a whole cylinder along a section extending in the axial direction. The axial direction of the cylinder of the recess 131 is the same as the thickness direction of the optical waveguide 100. The recess 131 has a substantially semicircular cross-section

Although the illustrated recess 131 has a substantially semicircular cross-section, the recess 131 may alternatively form the arc of a partial circle other than a semicircle, or may have another cross-sectional shape. The present embodiment is directed to a configuration in which the recesses 131 are formed on both sides of each core. This is not a limiting example, and the recesses 131 may be formed on both sides of at least one core.

The recess 131 may have a depth greater than or equal to 0.05 mm and less than or equal to 0.15 mm. The depth of the recess 131 is equal to the distance between the end face 130 and the point on the recess 131 farthest away from the end face 130 in the Y direction. The range of the depth of the recess 131 will be described later.

A planar section 132 situated at the center of the end face 130 has no recesses 131. Provision of the planar section 132 ensures a sufficient mechanical strength at the tip of the optical waveguide 100 inclusive of the end face 130, thereby reducing deformation of the optical waveguide 100 upon bonding the optical waveguide 100 to the ferrule.

If the recesses 131 were formed to overlap the cores 110, no cladding would be provided at the point between the recesses 131 and the cores 110. In the absence of cladding, light would not be fully reflected inside the cores, which results in optical loss. In consideration of this, the width of the recesses 131 is made shorter than the distance between the cores so as to avoid the removal of a cladding covering the cores 110.

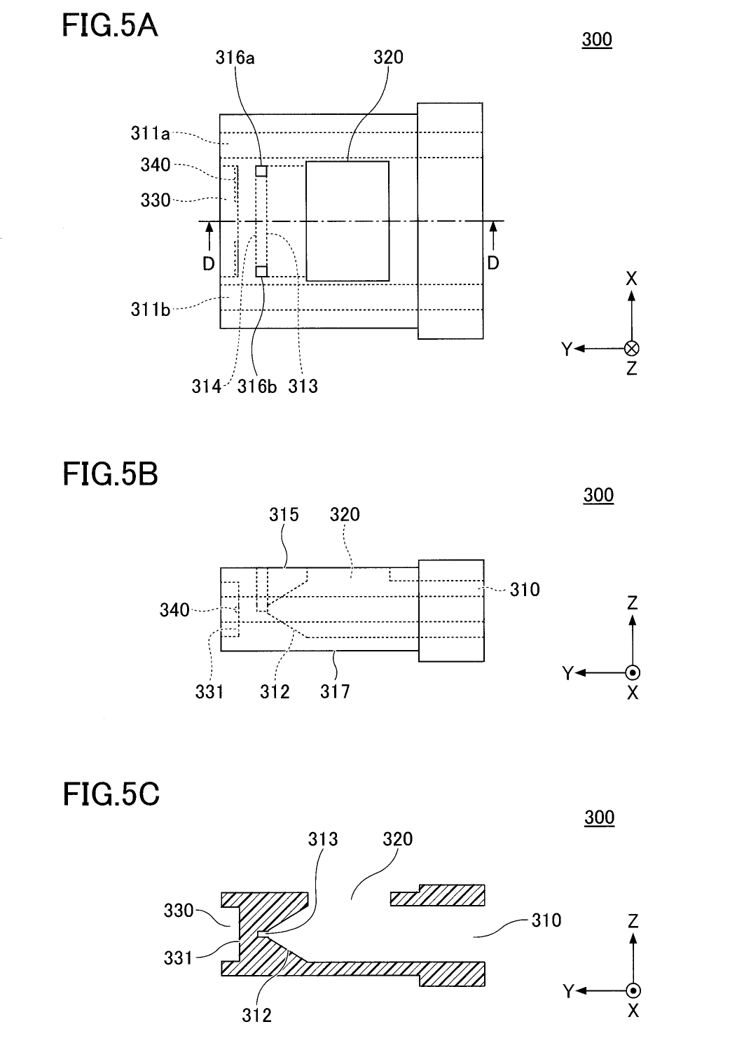

A ferrule according to the present embodiment will be described with reference to FIGS. 5A through 5C. FIG. 5A is a top view of the ferrule of the present embodiment. FIG. 5B is a side elevation view of the ferrule. FIG. 5C is a cross-sectional view taken along the line identified by arrows D in FIG. 5A.

A ferrule 300 accommodates the optical waveguide 100 in a secure manner. The optical waveguide 100 is connected to the ferrule 300 to form an optical connector, which is then connected to another optical device.

The ferrule 300 may be made of a transparent resin, for example. It is preferable for the refractive index of the resin used as the material of the ferrule 300 to be substantially equal to the refractive index of the cores 110. Ensuring a substantially equal refractive index in the ferrule 300 and the cores 110 reduces the reflection of light at an interface between these two parts, which reduces optical loss.

The ferrule 300 has a receptacle 310, a window 320, a cavity 330, a link 311a, and a link 311b.

The receptacle 310, which is an opening for receiving the optical waveguide 100 inserted into the ferrule 300, is a hole extending in the Y direction. A taper 312 is formed near the back end (i.e., deepest end) of the receptacle 310. The width of the space defined by the taper 312 in the Z direction narrows toward the positive Y direction. A slit 313 is formed at the tip of the taper 312 to receive an optical waveguide. The slit 313 is an example of a receiving part.

The slit 313 is a thin rectangular recess having a shorter extension in the Z direction than in the X direction. The slit 313 is formed inside the ferrule 300.

The end of the slit 313 has a contact face 314. The contact face 314 is a flat surface that faces the end face 130 of the optical waveguide 100 and that is connected to the end face 130 via an adhesive. The opposite ends of the slit 313 have discharge holes 316a and 316b. The discharge holes 316a and 316b extend from the slit 313 to the top face 315.

The discharge holes 316a and 316b, which have substantially the same shape, are positioned at the symmetric positions relative to the center line of the slit 313. The cross-sections of the discharge holes 316a and 316b are rectangular. The exterior face of the ferrule 300 to which the discharge holes 316a and 316b are connected is not limited to the top face 315, and may alternatively be a bottom face 317. Alternatively, the discharge holes 316a and 316b may be penetrating holes extending from the top face 315 to the bottom face 317.

The discharge holes 316a and 316b are not formed at the center area of the slit 313. With this arrangement, the center area of the optical waveguide 100 is securely held between the faces of the slit 313, so that the optical waveguide 100 is prevented from deforming upon being inserted into the slit 313.

The window 320, which is a hole formed in the top face 315, is utilized to insert a drip tool such as a dispenser for dripping an adhesive into the slit 313.

The cavity 330 is a rectangular recess formed in the exterior face of the ferrule 300 which is situated opposite the contact face 314. The cavity 330 has a lens-disposed face 331 situated opposite the contact face 314. The lens-disposed face 331 has micro-lenses 340. The ferrule 300 and the micro-lenses 340 may be made of a resin and formed together as a single, seamless piece by injection molding.

The micro-lenses 340 are in one-to-one correspondence with the respective cores 110. The micro-lenses 340 are aligned at equal intervals in the X direction at the positions corresponding to the respective cores 110. The micro-lenses are not formed at the center area of the ferrule 300.

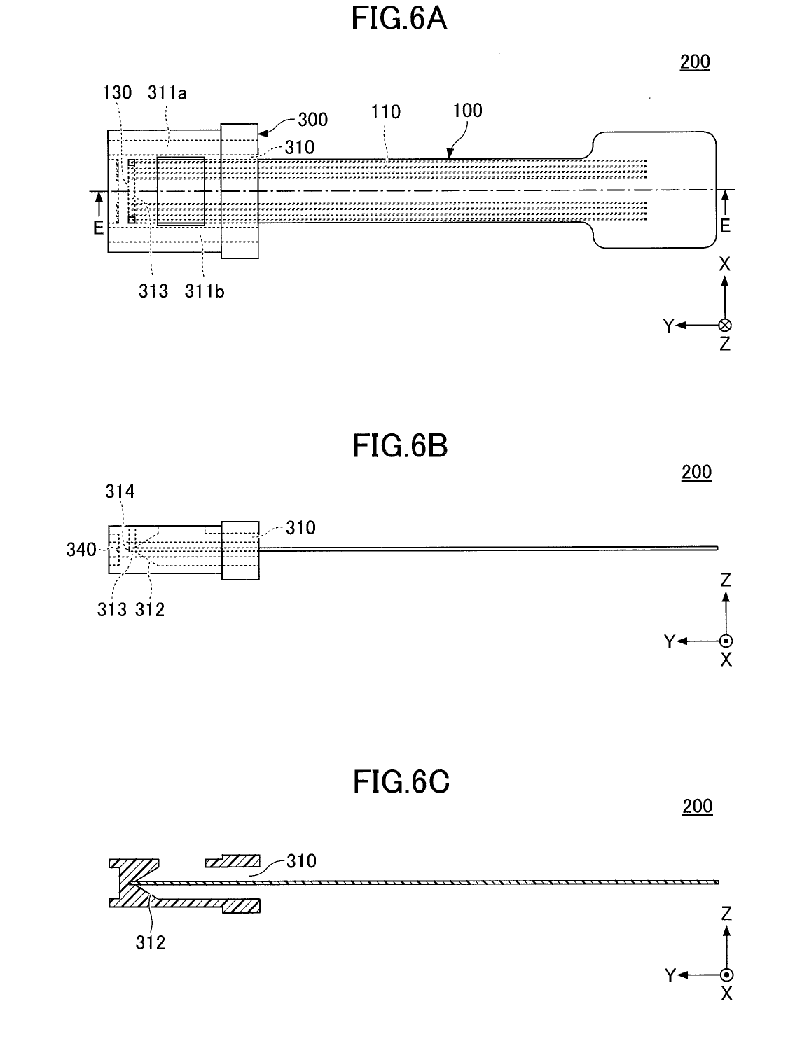

An optical module according to the present embodiment will be described with reference to FIGS. 6A through 6C. FIG. 6A is a top view of the optical connector of the present embodiment. FIG. 6B is a side elevation view of the optical connector. FIG. 6C is a cross-sectional view taken along the line identified by, and viewed in the direction of, arrows E in FIG. 6A. An optical connector 200 illustrated in FIG. 6A includes the optical waveguide 100 and the ferrule 300.

The optical waveguide 100 is inserted into the ferrule 300 at the receptacle 310. The tip of the optical waveguide 100 is inserted into the slit 313 through the taper 312. The end face 130 is bonded to the contact face 314 with an adhesive. With the end face 130 being bonded to the contact face 314, the optical waveguide 100 is connected to the ferrule 300.

The adhesive may be an ultraviolet curing adhesive having substantially the same refractive index as the cores 110 and the ferrule 300. Use of a refractive index substantially equal to that of the cores 110 and the ferrule 300 prevents the reflection of light at an interface between the adhesive and either the end face 130 or the contact face 314, thereby reducing optical loss.

The thickness and width of the slit 313 substantially match the thickness and width of the tip of the optical waveguide 100, respectively. With this arrangement, inserting the optical waveguide 100 into the slit 313 causes the optical axes to be aligned between the cores and the micro-lenses.

The contact area between the slit 313 and the optical waveguide 100 within the X-Y plane is designed to be such an amount that the optical waveguide 100 does not deform upon being bonded to the ferrule 300.

The links 311a and 311b are used for positional alignment when connecting the optical connector 200 to another optical connector.

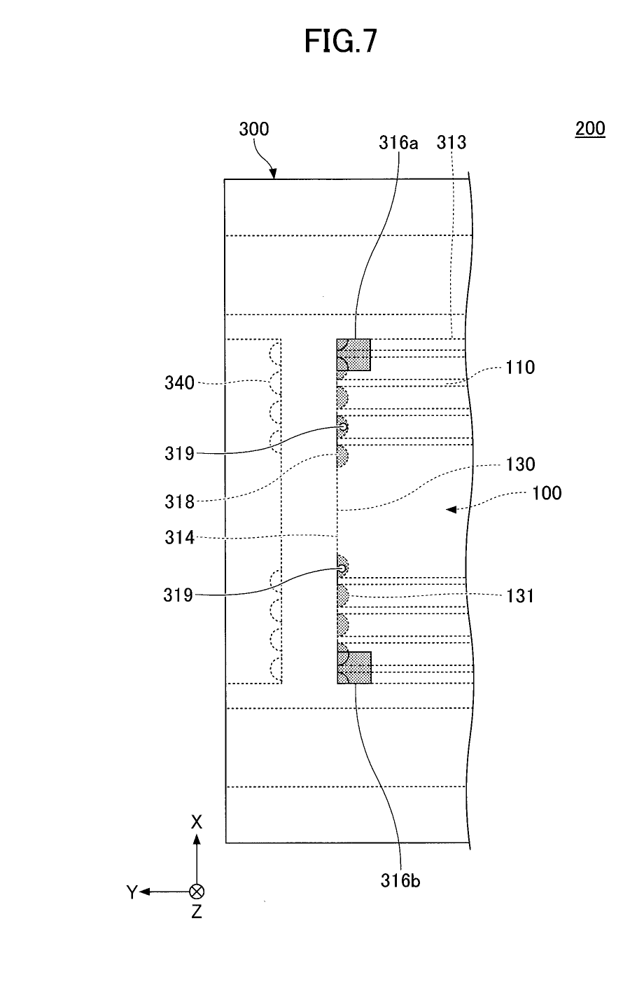

FIG. 7 illustrates the portion of the optical connector 200 where the optical waveguide 100 is bonded to the ferrule 300. FIG. 7 illustrates the end face 130 pressed against the contact face 314.

One of the features of the optical connector 200 is that the recesses 131 are provided on both sides of the cores at the end face 130. With this arrangement, gaps corresponding to the recesses 131 are formed when the end face 130 is pressed against the contact face 314.

As was previously described, bubbles having relatively large diameters, which receive a relatively great force from the flow of an adhesive or the like, are readily carried by the flow of an adhesive. At the time of bonding the optical waveguide 100 to the ferrule 300, thus, these bubbles move to the side ends of the slit 313 as the end face 130 is brought closer to the contact face 314, resulting in being ejected to the outside through the discharge holes 316a and 316b.

In contrast, bubbles having relatively small diameters, which are not likely to receive a significant force from the flow of an adhesive, do not readily move with the flow of an adhesive. In the present embodiment, provision of the gaps corresponding to the recesses 131 situated near the cores allow bubbles having relatively small diameters to enter these gaps through only a small amount of movement. An adhesive 318 illustrated in FIG. 7 flows into each of the gaps corresponding to the recesses 131 as well as into the discharge holes 316a and 316b. Bubbles 319 are captured in the gaps of the recesses 131 together with the adhesive 318.

Capturing bubbles in the gaps of the recesses 131 as described above ensures that not only bubble having relatively large diameters but also bubbles having relatively small diameters escape from the optical paths between the cores 110 and the contact face 314, which is made by connecting the optical waveguide 100 to the ferrule 300. Fresnel reflection loss caused by bubbles is thus avoided, which prevents reduction in optical transmission efficiency.

It may be noted that bubbles causing Fresnel reflection loss are those which have diameters greater than or equal to 0.045 mm. In consideration of this, the optical waveguide 100 is configured such that the depth of the recesses 131 is greater than or equal to 0.05 mm to be able to accommodate bubbles whose diameters are greater than or equal to 0.045 mm.

Further, when the depth of recesses 131 is greater than 0.15 mm, the tip of the optical waveguide 100 has insufficient strength, which may result in the tip becoming deformed upon insertion into the slit 313. In the present embodiment, thus, the depth of the recesses 131 is less than or equal to 0.15 mm in order to avoid the deformation of the optical waveguide 100.

Each of the recesses 131 is a cylindrical concave surface whose cross-section constitutes part of a circumference. Such a shape allows the adhesive 318 to spread across the entire inner surface of the recess 131 rather than to reside in a locally limited area within the recess 131. The optical waveguide 100 is thus prevented from deforming due to variation in contraction caused by the local concentration of the adhesive.

A method of making the optical waveguide 100, the ferrule 300, and the optical connector 200 will be described.

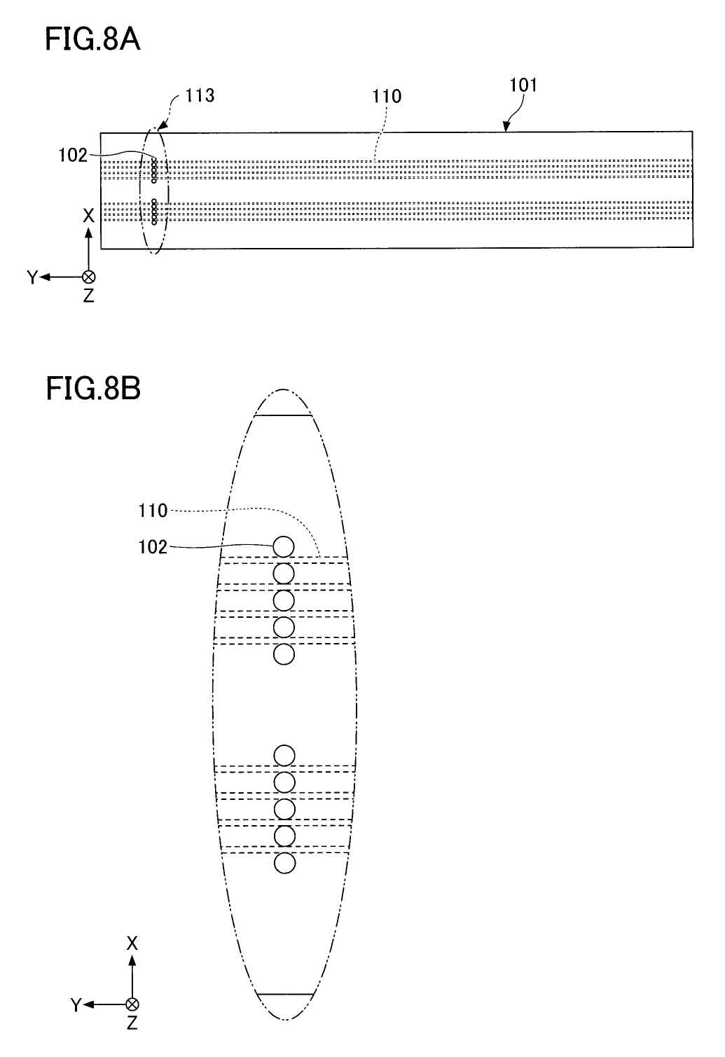

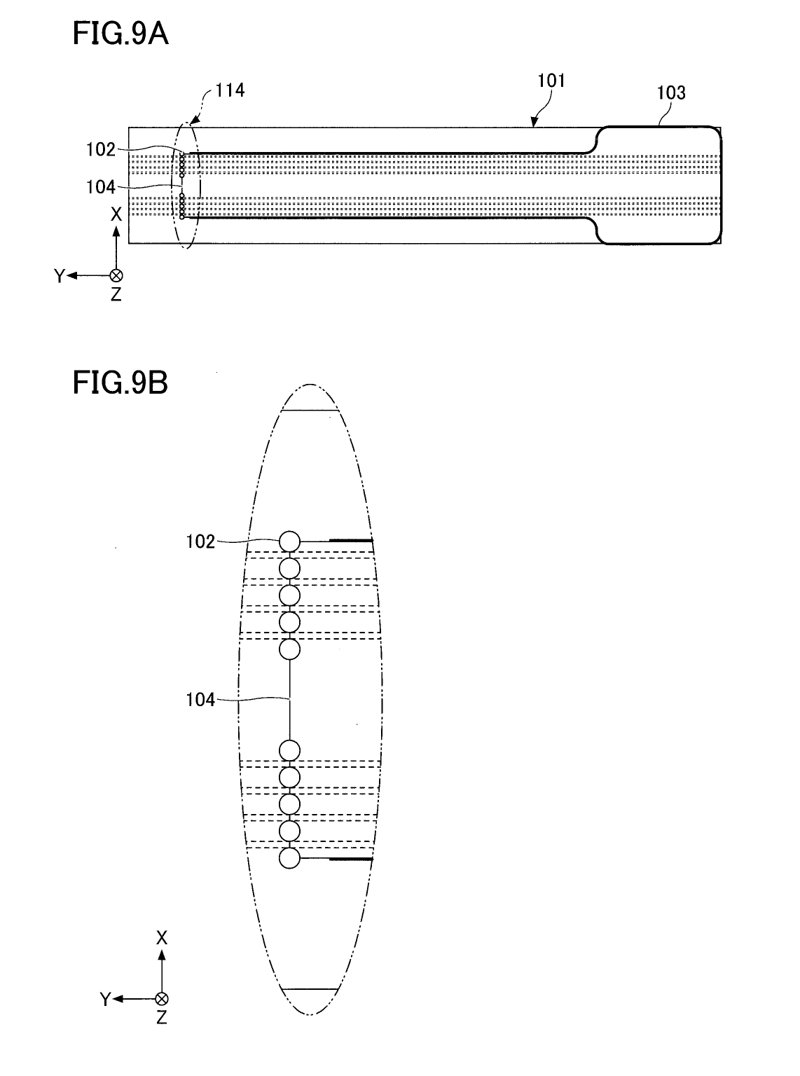

A method of making the optical waveguide 100 will be described by referring to FIGS. 8A and 8B and FIGS. 9A and 9B. FIGS. 8A and 8B are drawings illustrating a process of making holes through the optical waveguide 100. FIG. 8A is a top view of a film 101. FIG. 8B is an enlarged view of an area 113 enclosed by a two-dot and dash line in FIG. 8A. The portion illustrated in FIG. 8B is subsequently processed to form the end face 130.

In FIG. 8B, penetrating holes 102 are made on both sides of the cores 110 in the X direction. The penetrating holes 102 are cylindrical holes penetrating the film 101 in the Z direction. The penetrating holes 102 may be made by a laser process utilizing an excimer laser.

The center area of the film 101 illustrated in FIGS. 8A and 8B corresponds to the planar section 132 of the optical waveguide 100, and, thus, does not have the penetrating holes 102.

Use of circular penetrating holes 102 allows the penetrating holes 102 and the recesses 131 to be easily made. Further, a laser process, which is suitable for high-speed processing, becomes usable in the making of the penetrating holes 102.

A process of cutting the optical waveguide 100 will be described by referring to FIGS. 9A and 9B. FIG. 9A illustrates the film 101 having the penetrating holes 102. FIG. 9B is an enlarged view of an area 114 illustrated in FIG. 9A. The portion illustrated in FIG. 9B is processed to form the end face 130.

The thick solid lines 103 illustrated in FIG. 9A indicate the lines along which cuts are made by use of a cutter or the like. A cut plane 104 at and around the penetrating holes 102 corresponds to the end face 130. Due to the fact that the cut plane 104 requires higher surface precision than do the solid lines 103, a dicing saw or the like may be used as a cutting tool.

A cut by the dicing saw is made such that the cut plane intersects the centers of the penetrating holes 102. Part of the penetrating holes 102 is left to form the recesses 131 having semicircular cross-sections at the end face 130.

The cross-sectional shape of the recesses 131 is not limited to a semicircle. The points of the penetrating holes 102 which the cut plane 104 intersects may be displaced in the Y direction so as to provide the recesses 131 having a different form that is part of a circumference. Alternatively, the recesses may be formed in any shape such as a rectangle or a triangle.

The depth of the recesses 131 may be changed by changing the diameter of the penetrating holes 102 or by shifting the position of the cut plane 104 intersecting the penetrating holes 102 in the Y direction.

In the manner described above, the optical waveguide 100 is completed in final form.

The ferrule 300 may be made by injection molding that utilizes a mold.

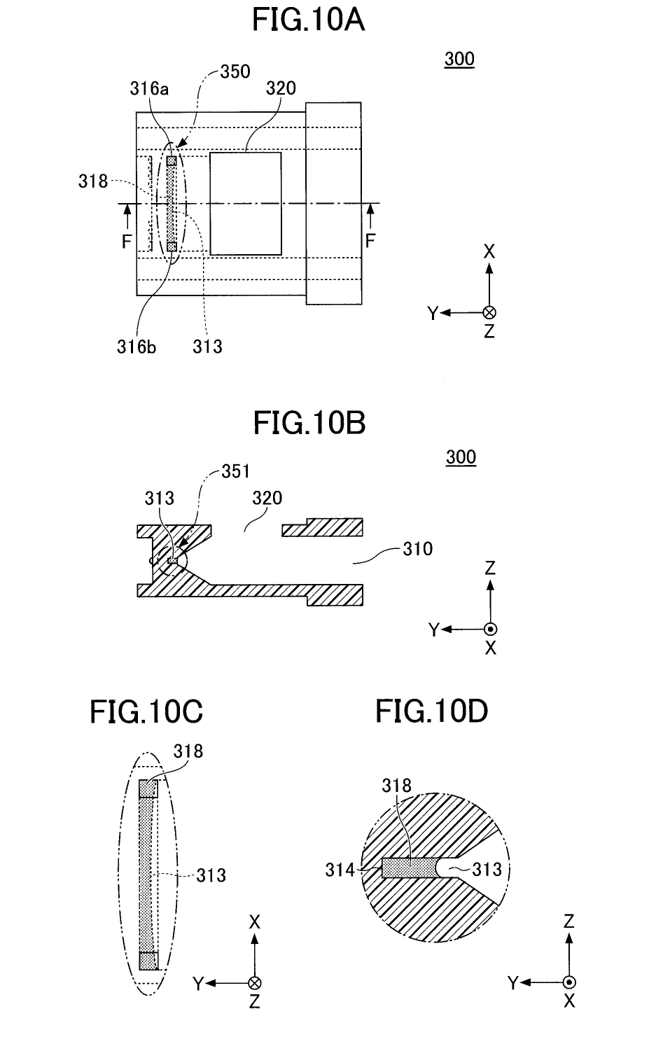

A process of bonding the optical waveguide 100 to the ferrule 300 will be described with reference to FIGS. 10A through 10D. FIG. 10A is a top view of the ferrule 300. FIG. 10B is a cross-section taken along the line defined by arrows F in FIG. 10A. FIG. 10C is an enlarged view of an area 350 illustrated in FIG. 10A. FIG. 10D is an enlarged view of an area 351 illustrated in FIG. 10B.

Portions shown in gray in FIGS. 10A through 10D indicate the adhesive 318 filling the slit 313. The adhesive 318 may be an ultraviolet curing adhesive having the same refractive index as the ferrule 300 and the cores 110, for example.

The adhesive 318 is dripped onto the slit 313 through the window 320. The dripped adhesive 318 seeps into the slit 313 through capillary action as illustrated in FIGS. 100 and 10D.

After the adhesive sufficiently seeps into the slit 313, the optical waveguide 100 is inserted into the slit 313 through the receptacle 310, so that the end face 130 is pressed against the contact face 314. Due to the pressing action, bubbles having relatively large diameters are ejected to the outside of the ferrule 300 through the discharge holes 316a and 316b. Bubbles having relatively small diameters are captured in the gaps formed by the recesses 131.

With the end face 130 being pressed against the contact face 314, the adhesive 318 is irradiated with ultraviolet light for curing, which results in the optical waveguide 100 being bonded to the ferrule 300.

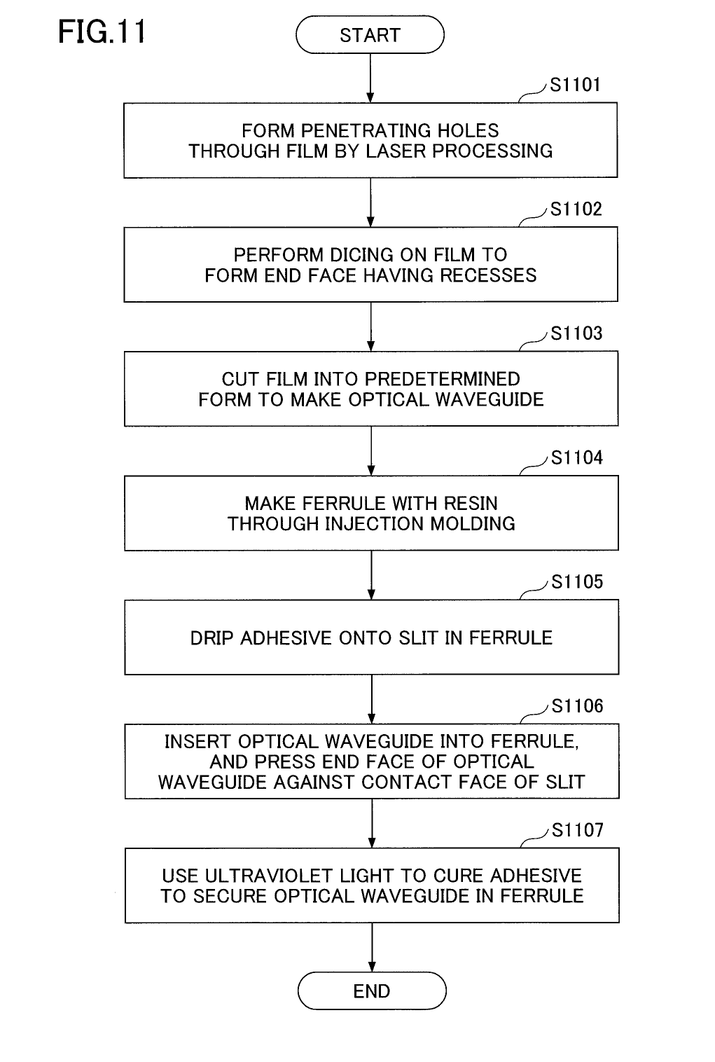

A method of making the optical connector 200 will be described with reference the flowchart illustrated in FIG. 11.

The penetrating holes 102 are made through the three-layer film 101, which subsequently becomes the optical waveguide 100 (S1101).

A dicing is performed on the film 101 to make the end face 130 having the recesses 131 (S1102).

The film 101 is then cut to make the optical waveguide 100 (S1103).

A mold is used to shape a resin through injection molding to make the ferrule 300 (S1104).

A dispenser is brought to the window 320 to drip the adhesive 318 onto the slit 313. The dripped adhesive 318 seeps into the slit 313 through capillary action (S1105).

The optical waveguide 100 is inserted into the ferrule 300 through the receptacle 310, followed by inserting the tip of the optical waveguide 100 into the slit 313. The end face 130 is pressed against the contact face 314 with the adhesive 318 intervening therebetween (S1106).

Exposure to ultraviolet light cures the adhesive 318, to bond the optical waveguide 100 to the ferrule 300 (S1107).

According to the embodiments described above, an optical waveguide is provided that prevents bubbles from remaining in the optical path upon bonding the optical waveguide to a ferrule.

In addition to the above-noted advantages, further advantages are provided as follows.

The width of the recesses may be made smaller than the distance between the cores, which prevents the cladding covering the cores from being removed, thereby avoiding optical loss.

Provision of the flat plane section that is situated at the center of the end face and that is wider than the distance between the cores reduces deformation of the optical waveguide when the tip of the optical waveguide is inserted into the receiving part.

Further, although the one or more embodiments of the present invention have been described heretofore, the present invention is not limited to these embodiments, and various variations and modifications may be made without departing from the scope of the present invention.

The present application is based on and claims priority to Japanese patent application No. 2018-061590 filed on Mar. 28, 2018, with the Japanese Patent Office, the entire contents of which are hereby incorporated by reference.

What is claimed is

1. An optical waveguide for connection to a ferrule, comprising:
a plurality of cores; and
a cladding covering the cores,
wherein the cladding has recesses at an end face of the optical waveguide.

2. The optical waveguide as claimed in claim 1, wherein the recesses are situated on both sides of the cores at the end face.

3. The optical waveguide as claimed in claim 1, wherein a width of the recesses is smaller than a distance between the cores.

4. An optical connector, comprising:
an optical waveguide including a plurality of cores an a cladding covering the cores; and
a ferrule connected to the optical waveguide,
wherein the cladding has recesses at an end face of the optical waveguide, and the ferrule has a contact face that is bonded through adhesive to the end face.

5. The optical connector as claimed in claim 4, wherein the ferrule has a receiving part configured to receive a tip of the optical waveguide inclusive of the end face, and has one or more discharge holes extending from the receiving part to an exterior surface of the ferrule.
